(19) United States
(12) Patent Application Publication
(10) Pub. No.: US 2004/0260851 A1
(43) Pub. Date: Dec. 23, 2004

(54) Data transmission method for microprocessors in a programmable logic controller

(76) Inventor: Chun-Yen Tu, Taoyuan (TW)

Correspondence Address: BIRCH STEWART KOLASCH & BIRCH, PO BOX 747, FALLS CHURCH, VA, 22040-0747, US

(21) Appl. No.: 10/645,510

(22) Filed: Aug. 22, 2003

(30) Foreign Application Priority Data
Jun. 17, 2003 (TW) 92116442

(51) Int. Cl. G06F 13/42

(52) U.S. Cl. 710/105

(57) ABSTRACT

A data transmission method for microprocessors is accomplished by using an I/O pin to transmit data signals while another one to transmit pulse-wave signals, wherein the data signal consists of a command code character, an initial address character, a data-length character, and at least one data-conception character, and each character consists of eight data bits, one parity bit, and one responding bit.

### BACKGROUND OF THE INVENTION

1. Field of Invention

The invention relates to a data transmission method for microprocessors in a programmable logic controller and, in particular, to a communication protocol that greatly reduce the number of necessary I/O pins for data transmissions.

2. Related Art

The programmable logic controller is a solid-state electronic device. It uses the feedback signals from I/O devices and stored routines to perform mechanical controls or procedure operations. The programmable logic controller is mainly comprised of a central processing unit and an I/O module interface. The central processing unit is usually a microprocessor.

The data transmissions among microprocessors can be parallel or serial. The parallel transmission takes several bits as a transfer unit to transmit at the same time. In other words, each bit in the transmitted data has its own channel and all bits are transmitted simultaneously. Therefore, its transmission speed is faster. However, the parallel transmission requires more channels (more I/O pins) and thus has a higher cost. Consequently, it is mostly used in short-distance transmissions.

The serial transmission breaks the data into individual bits and transmits them out one by one. The bits are recombined once they are received. In other words, each bit in the transmitted data has to go through the same channel in order. The existing major serial transmission interfaces include Universal Asynchronous Receiver Transmitter (UART), SPI and 12C.

The UART is an important interface for the microprocessors to communicate with the exterior. It is used mainly for serial/parallel data conversions. Although most microprocessors are equipped with this module, it nevertheless has the disadvantage of automatically or arbitrarily selecting the data transmission rate.

The SPI and 12C interfaces are not very popular at the moment. If the microprocessors are not equipped with one of these modules, it is impossible to achieve rapid data transmissions.

### SUMMARY OF THE INVENTION

A primary objective of the invention is to provide a communication protocol that can reduce the number of I/O pins needed for data transmissions among microprocessors in a programmable logic controller and can flexibly adjust the data transmission rate.

To achieve the above objective, the disclosed data transmission method for microprocessors in a programmable logic controller uses an I/O pin of the master microprocessor to send and receive data signals, while using another I/O pin to transmit pulse-wave signals.

The slave microprocessors also use one I/O pin to send and receive data signals, while using another I/O pin to receive the pulse-wave signals.

The data signal includes a command code character, an initial address character, a data-length character, and at least one data-conception character. The first through fourth bits of the command code character determines the data transmission rate. The fifth bit confirms the transmission rate. The sixth through eighth bits define the transmission protocol. The ninth bit sends a same bit to check whether the data transmissions have any error. The tenth bit is the responding bit to make sure that the data transmissions are complete.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus are not limitative of the present invention, and wherein:

FIG. 1 is a circuit block diagram of the invention;

FIG. 2 is a schematic view of the data signal format used in the invention; and

FIG. 3 is a schematic view of the command code character and pulse-wave signals.

### DETAILED DESCRIPTION OF THE INVENTION

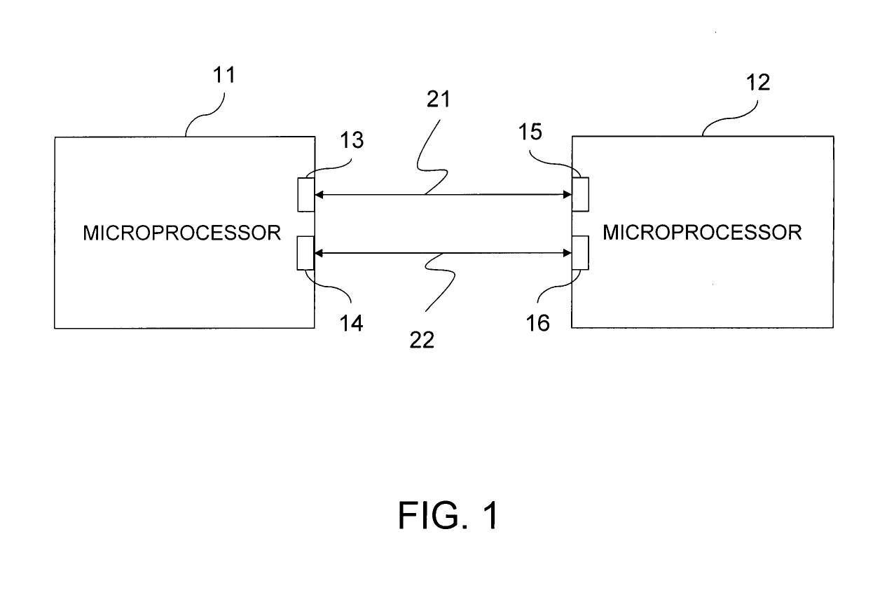

As shown in FIG. 1, the disclosed data transmission method for microprocessors in a programmable logic controller defines two microprocessors 11, 12 as a master and a slave. The master microprocessor 11 uses one I/O pin 13 to send and receive data signals 21 to/from the slave microprocessor 12 and another I/O pin 14 to send pulse-wave signals 22 to the slave microprocessor 12.

The slave microprocessor 12 also uses one I/O pin 15 to send and receive data signals 21 to/from the master microprocessor 11 and another I/O pin 16 to receive the pulse-wave signals 22 from the master microprocessor 11.

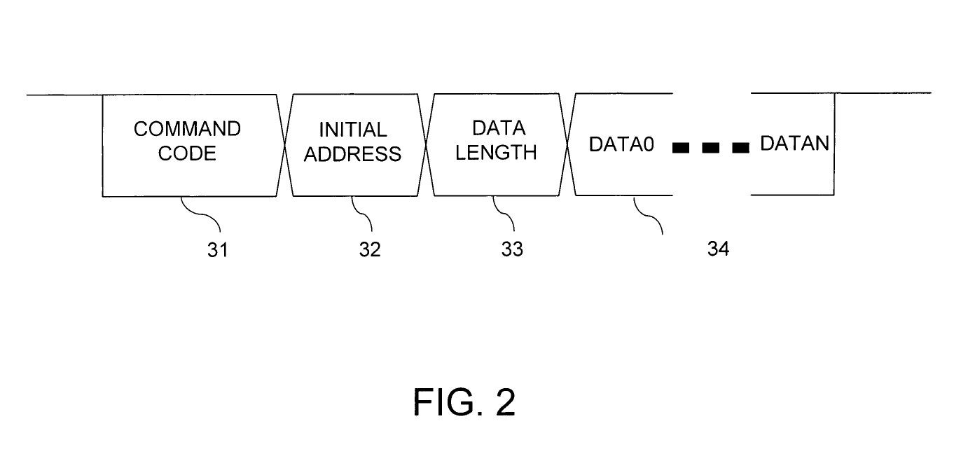

With reference to FIG. 2, the data signal 21 has a command code character 31, an initial address character 32 following the command code character 31, a data-length character 33 following the initial address character 32, and at least one data-conception character 34 following the data-length character 33. Each character consists of ten bits: eight data bits, one parity bit and one responding bit. The command code character 31 defines the initial value of data. The initial address character defines the initial address of data. The data-length character 33 defines the length of data.

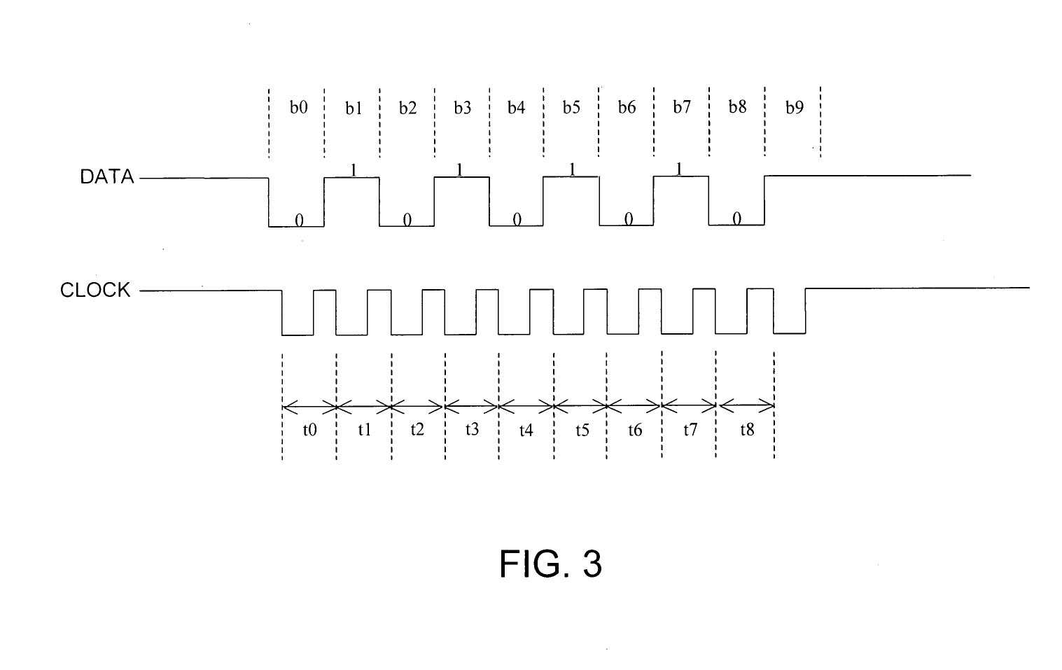

With reference to FIG. 3, the command code character 31 remains at state 1 (MARK) before data are transmitted. When the first four bits (b0 to b3) sent out by the master microprocessor 11 are the 0101 state, the slave microprocessor 12 records the time of each bit using the pulse-wave signals 22. When the fifth bit (b4) sent by the master microprocessor 11 is the 0 state (SPACE), the slave microprocessor 12 computes the data transmission rate according to the time required for the master microprocessor 11 to send out the first five bits (from t0 to t3). When the master microprocessor 11 sends out the sixth bit (b5), the slave microprocessor 12 uses the pulse-wave signals to check whether the needed time t4 is consistent with that previously computed data transmission rate.

If the slave microprocessor 12 determines that t4 is consistent with the data transmission rate, then it continues to receive data. The sixth through eighth bits (b5 to b7) define the transmission protocol between the master microprocessor and the slave microprocessor 12. If they are the 000 state, then it means the 16-bit read-out mode. The 011 state means the 8-bit read-out mode. The 101 state means the 16-bit write-in mode, and the 110 state means the 8-bit write-in mode.

The ninth bit (b8) is the parity bit for sending the same bit as a check. If the ninth bit is 0, then it means the even-parity check mode. If the ninth bit is 1, then it is the odd-parity check mode.

The tenth bit (b9) is a slave responding bit. If it is 1, it means that the slave microprocessor 12 has correctly received the signal from the master microprocessor 11 and data transmissions can start. If it is 0, then the slave microprocessor 12 has not correctly received the signals from the master microprocessor 11.

In summary, the invention has the following advantages:

1. The serial transmission used in the invention only requires two I/O pins of each microprocessor for data transmissions. One I/O pin sends data signals, whereas the other sends pulse-wave signals. This greatly improves from the conventional parallel transmissions that need too many pins.

2. The invention uses the command code character to determine the data transmission rate between two microprocessors. It can flexibly adjust the initial address as an 8-bit address or 16-bit address.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data transmission method for microprocessors in a programmable logic controller, which defines two microprocessors as a master microprocessor and a slave microprocessor, which method is characterized in that: the master microprocessor and the slave microprocessor have two corresponding I/O pins for sending and receiving data signals through one pin and sending pulse-wave signals through the other.

2. A data signal used in a data transmission method for microprocessors in a programmable logic controller comprising:
a command code character, which defines the initial value of data;
an initial address character, which follows the command code character and defines the initial address of data;
a data-length character, which follows the initial address character and defines the data length; and
at least one data-conception character, which follows the data length character.

3. The data signal used in a data transmission method for microprocessors in a programmable logic controller of claim 2, wherein the character comprises eight data bits, one parity bit, and a responding bit.

4. The data signal used in a data transmission method for microprocessors in a programmable logic controller of claim 2, wherein the first through fourth bits of the command code character determine the transmission rate of data.

5. The data signal used in a data transmission method for microprocessors in a programmable logic controller of claim 2, wherein the fifth bit of the command code character is used to confirm the transmission rate.

6. The data signal used in a data transmission method for microprocessors in a programmable logic controller of claim 2, wherein the sixth through eighth bits of the command code character defines the transmission protocol of data.

7. The data signal used in a data transmission method for microprocessors in a programmable logic controller of claim 6, wherein a 16-bit read-out mode is selected if the sixth through eighth bits are 000.

8. The data signal used in a data transmission method for microprocessors in a programmable logic controller of claim 6, wherein an 8-bit read-out mode is selected if the sixth through eighth bits are 011.

9. The data signal used in a data transmission method for microprocessors in a programmable logic controller of claim 6, wherein a 16-bit write-in mode is selected if the sixth through eighth bits are 101.

10. The data signal used in a data transmission method for microprocessors in a programmable logic controller of claim 6, wherein a 16-bit write-in mode is selected if the sixth through eighth bits are 110.

11. The data signal used in a data transmission method for microprocessors in a programmable logic controller of claim 2, wherein the ninth bit of the command code character is a parity bit for sending the same bit as a check of data transmissions.

12. The data signal used in a data transmission method for microprocessors in a programmable logic controller of claim 2, wherein the tenth bit of the command code character is a responding bit for confirming that the data transmission is complete.
